(19) United States
(12) Patent Application Publication
(10) Pub. No.: US 2002/0176436 A1
(43) Pub. Date: Nov. 28, 2002

(54) Method for in a multi-station network determining a worst case gap_count value, and a system and a measuring node arranged for implementing such method

(76) Inventor: Antonio Elias Salloum Salazar, Eindhoven (NL)

Correspondence Address: U.S. Philips Corporation, 580 White Plains Road, Tarrytown, NY, 10591, US

(21) Appl. No.: 10/086,879

(22) Filed: Mar. 1, 2002

(30) Foreign Application Priority Data
Mar. 6, 2001 (EP) 01200841.3

(51) Int. Cl. H04L 12/28

(52) U.S. Cl. 370/431

(57) ABSTRACT

A method for operating a multi-station network for therein effecting node-to-node communications over a serial bus in a collision-free fashion, while having before starting such communication an communication originator station execute a gap_count procedure for therein measuring an idle interval, said method being characterized by the steps of:

measuring various path delay values between a first node and a second node;

selecting a worst case among said path delay values;

assigning a gap_count to said worst case delay value.

### BACKGROUND OF THE INVENTION

The invention relates to a method for providing dynamic gap optimization for a bus system, and in particular for an IEEE 1394-1995 bus, or IEEE 1394 for short. Various amendments have been proposed to this protocol, to which amendments the present invention is also applicable. The IEEE 1394 Standard defines a serial bus for use with various home electronics devices. More in particular, the method of the present invention should allow users and engineers to set up home networks with variable sizes as being based on such bus system. In fact, a home network may comprise quite diverse items, such as audio-video sets, Personal Computers, surveillance cameras, household appliances, and other, and as such will be liable to frequent changes, such as through the adding or removing of one of the stations. The inventive method should allow the use of state-of-the-art 1394-standardized stations without requiring extensive computational complexity for its implementation.

Now, the bus standard has its traffic effected in data packets, that can be sent through the cabled connection in a collision-free fashion when abiding certain rules of access. The traffic will be controlled through a mechanism that provides so-called gaps, which each define an interval of time during which the bus must remain idle. Before starting a transmission, the intended origin station in question listens to the existing bus traffic, and checks for the occurrence of a suitable gap as compared to an applicable gap_count.

The stations are interconnected according to a logical tree topology. This is one of the reasons that the length of a particular gap, as measured by the various stations, may have widely different values: in fact, the physical distances between the various stations may be quite non-uniform. Non-adherence by a station to the prescribed gap length may cause data packet overlap or data loss, which may be associated to sometimes catastrophic consequences.

The above standard allows to avoid these and other problems through specifying a minimum gap_count that immediately relates to a time delay that must be gone before a next packet can be transmitted, cf. Table 1. By in practice amending the actual value of this delay parameter, the listening gap can either be extended for still better avoiding collisions, or rather shortened for more efficiently using available bandwidth. The optimum value of the gap, as specified by Table 1, is commensurate with a particular physical construction of the inter-station connection for each of the so-called hops, that are the immediate physical interconnections between the stations. In particular, an interconnection cable of 4.5 meters length has been broadly standardized for implementing a hop.

However, the inventor has recognized a need for more flexibility. This would first apply to using other suitable interconnection media for the hops. Also, the hops may be made faster through choosing a smaller length. On the other hand, a longer cable allows interconnection to a far-away station, such as one lying between 4.5 meters and a few tens of meters away. A particular reason for requiring flexibility is to allow effecting a reconfiguration of the network.

Now, the inventor has recognized that in a real-time instance of such network the delays may in principle have widely and dynamically variable values, so that any prespecifying procedure would be inferior to a heuristic determination of actually occurring delays.

### SUMMARY TO THE INVENTION

In consequence, amongst other things, it is an object of the present to provide a straightforward delay measuring procedure in such network to allow retayloring of the subsequent gap count measurement for attaining an optimally economical yet reliable operation of the network.

Now therefore, according to one of its aspects the invention is characterized according to the characterizing part of Claim 1. In an optimal embodiment of the present invention, the measuring of the return trip delay from a single root node to all leaf nodes, a fast and reliable procedure is attained, that will approximately yield the optimum travel time value.

The invention also relates to a multi-station system arranged for implementing a method as claimed in Claim 1, and to an apparatus arranged for operating as a measuring node in a method as claimed in Claim 1. Further advantageous aspects of the invention are recited in dependent Claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a general binary tree network for use with the invention;

FIG. 2, a typical network for use with the invention;

FIG. 3, a subaction process for determining a Round Trip Delay (RTD) value;

FIG. 4, a flow chart of the operation;

Table 1, Static Gap Count Optimization Values.

### DETAILED DESCRIPTION OF PREFERRED EMBODIMENTS

Now, the dynamic gap count optimization of the present invention is implemented in a two-step algorithm: first, the maximum value of the round-trip delay is determined, and subsequently, the gap count is calculated from the measured value of the measured maximum value of the Round Trip Delay.

Measuring the maximum value of the round trip delay in a given network must be done according to an ad-hoc procedure after the initialization phase of the network in question has already been started. In a tree topology network, the longest value of such round-trip delay will generally come from a path that directly or indirectly interconnects two leaf-nodes of the tree. The embodiment will thus need some procedure for systematically evaluating and comparing the measured delay values. An ad-hoc procedure may have the logical map of the network contained in the root node. The measurement procedure will then generally also be executed by this root node. Furthermore, from a hardware point of view, two registers may then be available to the bus manager: a first one to load the actually highest value for the Round Trip Delay, and a second one to validate this highest value.

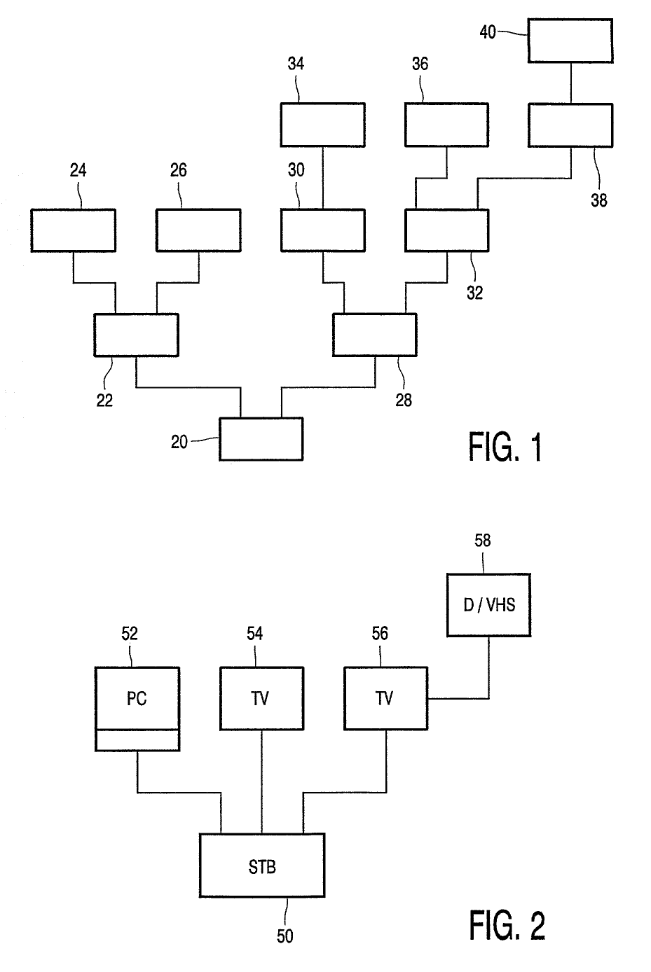

After a bus reset, the topology and speed maps of the network will be available in the bus manager. FIG. 1 illustrates a general binary tree network for use with the invention. In the embodiment, root node 20 has a map of the logical network. As shown, other nodes 22 through 40 are interconnected in such manner that each node has zero, one or two connected nodes in a higher network layer. Nodes 24, 26, 34, 36 and 40 are leaf nodes in that they connect no node at a higher layer level. In principle, higher numbers for the interconnection multiplicity are feasible. Persons skilled in the art will recognize that exactly the same network may be represented in a different manner, such as by starting from another node as the root node. After an initialization phase, the leaf nodes and root node will have been identified. The bus manager node can be any node of the network with the required facilities in terms of memory. From the topology map, the root node will be able to read the identity of leaf nodes and will proceed to send an asynchronous data packet with no data to every leaf in a consecutive mode.

FIG. 2 illustrates a typical network for use with the invention in a consumer electronics environment. The nodes accommodate the following functions. Root node 50 has an SetTop Box (STB) Function. Leaf nodes 52, 54, 58 have Personal Computer, TeleVision set and Digital VHS functions, respectively. Non-leaf node 56 likewise has a TeleVision set functionality. Nodes of various different character may be included into in the network of FIG. 2.

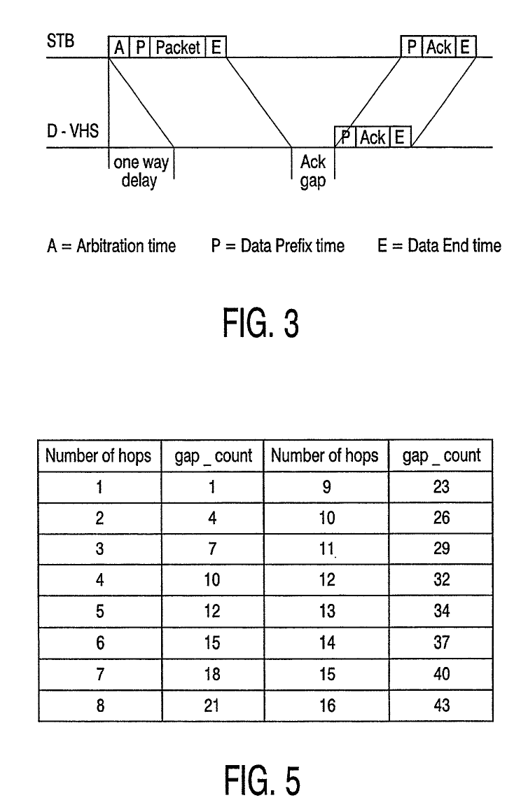

FIG. 3 illustrates a subaction process for determining a Round Trip Delay (RTD) value. In this case, the STB (root node) sends the asynchronous packet to the D-VHS that is one of the leaf nodes. Note that the subaction process will include an automatic acknowledge as an essential element that will be sent back by the receiving leaf node after the required acknowledge gap. Moreover, there is additional 1394 overhead time, associated to arbitration, data prefix, and data end, respectively. In the Figure, A is the Arbitration time, P the Data Prefix time, and E the Data End time. Now, let dⱼ be the round-trip delay in the path from the root node to the leaf node indexed j as shown in FIG. 3: dⱼ=2* one way delay (1). A similar time value may be estimated by determining the difference between the acknowledge arrival time and the packet delivery time, whilst excluding the contributions from data end, acknowledge gap, and data prefix. The overhead values are indeed constants given by the 1394 standard that can be loaded locally into the root node and be subsequently used during the above calculations.

The root node recursively registers the measured round trip delay for every leaf node. In the example of FIG. 2, three values will be registered. Once all leaf nodes have been processed, the maximum RTD of the network is estimated as

RTDₘₐₓ=maxₛ{dᵢ+dⱼ; ∀i≠j} (2)

Herein, S is the set of leaf nodes. The value obtained is loaded into a given register of the bus manager and a validation register is set, in order to indicate that the determination has been made. All procedures at the root node can be implemented in C code based on an available '1394 stack.

Calculation of the Gap Count from Determined Maximum RTD in the Network

While the validation register has not yet been set, the bus manager continues to wait for the measured maximum RTD. When the validation register is set, the bus manager reads the value of RTD and calculates the gap count using

$$gap\_count = ceiling ( \frac{{BR}_{max} * {BR}_{min} * ( {RTD}_{max} + AT ) - 51 * {BR}_{min} + 29 * {BR}_{max}}{32 * {BR}_{min} - 20 * {BR}_{max}} ) \qquad ( 3 )$$

where BRₘₐₓ=98.314 Mbit/s and BRₘᵢₙ=98.294 Mbit/s are the maximum and minimum base rate in the bus, respectively, AT is an additional timing due to the internal delay in the leaf nodes and can be estimated as 308 ns, and ceiling ( ) rounds the argument to the nearest integer toward infinity. At the bus manager, such an equation can be included in the C-language code of the used application to replace Table 1.

The Bus manager compares the gap count with the calculated value and in case of need will send the calculated value to every node.

Applicability

The dynamic gap count optimization can be applied in current 1394 compliant products by using the available stack, topology map, subaction process, bus manager, etc. It solves the problem of a variable size network allowing larger flexibility to the final user.

Annex: Deduction of Equation (3)

For an adequate operation of a '1394 network, the most restrictive requirement is that the arbitration reset gap, arb_res_gap, be greater than the subaction gap, subact_gap, under a worst case condition. Mathematically, this is expressed as

Subact_gapₘₐₓ<arb_res_gapₘᵢₙ (4)

where sub-indexes indicate maximum and minimum value, respectively. The right hand member of (4) can be expressed in terms of the gap count value, said gap_count, according to the '1394 standard:

$$arb\_res {\_gap}_{min} = \frac{( 51 + gap\_count * 32 )}{{BR}_{max}} \qquad ( 5 )$$

where BRₘₐₓ=98.314 Mbit/s is the maximum base rate in the bus. In a leaf-to-leaf path, the arb_res_gap seen by one leaf node (A) must be always greater than the subaction gap seen by the other leaf node (B). Under a worst case condition, the B leaf node sees the subaction gap as the sum of four terms, namely the maximum subaction delay, the maximum arbitration delay, the maximum RTD and an additional timing due to internal delay in the leaf nodes. The first two terms depends on the gap count value, the third one is obtained from direct measurement, and the last one is estimated by using the 1394 constants. Therefore, again according to the '1394 standard:

subact_gapₘₐₓ=subact_delayₘₐₓ+arb_delayₘₐₓ+RTDₘₐₓ+AT (6)

where

$$\begin{matrix}{subact\_delay}_{max} = \frac{( 29 + gap\_count * 16 )}{{Br}_{min}} & ( 7 ) \\ {arb\_delay}_{max} = \frac{gap\_count * 4}{{BR}_{min}} & ( 8 )\end{matrix}$$

AT=2*MAX_{—}ARB_{—}RESPONSE_{—}DELAY+DATA_{—}END_{—}DELAY (9)

The MAX_ARB_RESPONSE—DELAY and the DATA_END_DELAY can be estimated as 144 and 20 ns, respectively, again according to the '1394 standard. Herein, BRₘᵢₙ=98.294 Mbits/s is the minimum base rate in the bus. Replacing (5)-(9) in (4), we get the final result:

$$gap\_count = ceiling ( \frac{{BR}_{max} * {BR}_{min} * ( {RTD}_{max} + AT ) - 51 * {BR}_{min} + 29 * {BR}_{max}}{32 * {BR}_{min} - 20 * {BR}_{max}} )$$

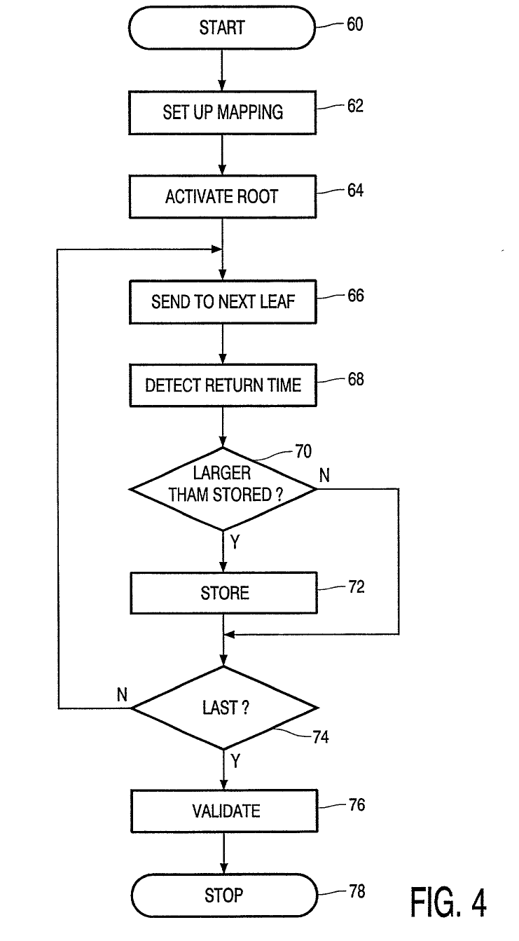

FIG. 4 illustrates a flow chart of the operation. In block 60, the operation starts, and all necessary hardware and software facilities are assigned. In block 62, the mapping of the physical nodes on a logical tree is effected, from which procedure the root node and the various leaf nodes will be identified. By itself, this is a prior art procedure. In block 64, the root is activated; generally, this is done by the root node itself. In block 66, the root node sends a data packet to the next-following leaf node. In block 68, the root node detects the acknowledge packet received from the node that the most recent data packet had been sent to; furthermore, the root node figures out the return time. In effect, this block includes a waiting loop not shown for clarity. In block 70, the root node detects whether the return time so measured is larger than the lowest value of the two values that had been stored. If positive, in block 72 the new value is stored. If negative, block 72 is passed by. In block 74, the root node detects whether the most recent leaf node was the last one of the set of leaf nodes. If negative, the procedure reverts to block 66. If positive, the procedure goes to block 76, wherein the two highest return times are validated, and the gap_count is determined according to the expression given hereabove.

Table 1 illustrates Static Gap Count Optimization Values. By themselves, these values have been known to persons skilled in the art.

1. A method for operating a multi-station network for therein effecting node-to-node communications over a serial bus in a collision-free fashion, whilst having before starting such communication a communication originator station execute a gap_count procedure for measuring an idle interval, said method being characterized by the steps of:
measuring various path delay values between a first node and a second node;
selecting a worst case among said path delay values;
assigning a gap_count to said worst case delay value.

2. A method as claimed in claim 1, wherein said path delay values each include an interval for returning an acknowledge packet.

3. A method as claimed in claim 1, wherein said measuring is effected by a single root node.

4. A method as claimed in claim 1, wherein said second node is limited to being a leaf node, and using all available leaf nodes as said second node.

5. A method as claimed in claim 1, wherein said measuring is effected by a single root node by measuring round trip delay values to all available leaf nodes.

6. A method as claimed in claim 5, wherein the two highest recorded round trip delay values are summed for therefrom determining an overall gap_count indication.

7. A multi-station system arranged for implementing a method as claimed in claim 1 and comprising a serial bus network for thereon in a collision-free fashion effecting node-to-node communications, furthermore comprising in a communication originator station gap_count setting means for executing a gap_count procedure for measuring an idle interval on said bus before starting such communication, said system furthermore being characterized by comprising
measuring means for measuring various path delay values between a first node and a second node;
selection means for selecting a worst case among said measured path delay values;
and assigning means for assigning a gap_count to said worst case delay value.

8. An apparatus being arranged for operating as a measuring node in a system as claimed in claim 7.
